(19) United States
(12) Patent Application Publication
(10) Pub. No.: US 2026/0318570 A1
(43) Pub. Date: Oct. 15, 2026

(54) INDOOR UNIT AND HEAT PUMP

(71) Applicant: Daikin Europe N.V., Oostende (BE)

(72) Inventors: Jose Daniel GARCIA LOPEZ, Oostende (BE); Michiel DECAESTECKER, Oostende (BE); Anil ISTANBULLU, Oostende (BE); Konstantinos BALADAKIS-KOTTAS, Oostende (BE)

(73) Assignee: Daikin Europe N.V., Oostende (BE)

(21) Appl. No.: 19/481,837

(22) PCT Filed: May 23, 2024
(86) PCT No.: PCT/EP2024/064244

§ 371 Date: Nov. 5, 2025

(30) Foreign Application Priority Data
May 26, 2023 (EP) 23175737.8
May 26, 2023 (EP) 23175739.4

(51) Int. Cl. F25B 30/02; F25B 41/31; F25B 43/00; G01M 3/04

(52) U.S. Cl. CPC F25B 30/02; F25B 41/31; F25B 43/00; G01M 3/04; F25B 2500/222; F25B 2600/2525

(57) ABSTRACT

The present disclosure relates to an indoor unit and a heat pump. An indoor unit for a heat pump installed inside of a building, comprising a part of a heat medium circuit for circulating a heat medium, an intermediate heat exchanger to exchange heat between a refrigerant and the heat medium, a gas-liquid separator provided in the heat medium circuit, the gas-liquid separator comprising a gas purge valve to release refrigerant, a container accommodating the intermediate heat exchanger, the gas purge valve, and the gas-liquid separator, and a first duct provided at the container, the first duct communicating an inside of the container with an outdoor space for air exchange between the inside of the container and the outdoor space, wherein the outdoor space is outside of the building.

### TECHNICAL FIELD

The present invention relates to an indoor unit and a heat pump.

### BACKGROUND ART

The development of heat pumps is facing a vast variety of requirements due to environmental and technical challenges. On the one hand, heat pumps should work as efficient as possible, whereas, on the other hand, the refrigerant used therein should avoid any environmental risks, such as ozone depletion or the potential to negatively influence the global warming.

When switching from non-flammable refrigerants to flammable refrigerants, increased care needs to be taken when handling the flammable refrigerants. In fact, leakage of flammable refrigerant into an indoor space, in which the heat pump or at least a part of the heat pump is installed, causes an indoor refrigerant concentration to increase, which potentially leads to formation of a flammable concentration region.

Such a concentration of leaked flammable refrigerant is dangerous, as flammable refrigerant oftentimes has a density greater than air under atmospheric pressure, such that the leaking flammable refrigerant accumulates in the bottom part of the indoor space, i.e. in a floor surface region thereof. This may lead to an inflammation and risks for users, buildings, etc.

Accordingly, it is desired to avoid such a formation of a flammable concentration region in an indoor space.

To do so, FR 3070755 A1 describes an approach having a box containing at least part of the heat pump system at an indoor space and having a sealed conduit that opens to the exterior of the building, so that leaking refrigerant can be exhausted to the exterior of the building. However, the compressor of FR 3070755 A1 being a possible ignition source is also placed inside the box. This is particularly dangerous when refrigerant is leaking inside the box and comes into contact with an ignition source like the compressor. This may lead to an increased inflammation risk. Furthermore, the degasser is arranged outside of the box in the indoor space and a separate piping is provided to transport the leaked refrigerant into the box. Since the degasser is arranged in FR 3070755 A1 outside of the box and in the indoor space, there is also the risk of a refrigerant leaking into the indoor space at a welded part of the piping or at a connection from the degasser to the box. Another aspect is that FR 3070755 A1 only comprises a single sealed conduit which may not ventilate the interior of the box sufficiently in case of leaking refrigerant. In the case of a leaking refrigerant, it is also not possible in the box of FR 3070755 A1 that accumulated liquid is transported from the box to the exterior of the building.

For heat pump systems it is also known to use a double-walled plate heat exchanger in the indoor unit in order to prevent a refrigerant leakage into a water circuit. However, the costs of double-walled heat exchangers are higher than of normal plate heat exchangers. When using a normal heat exchanger, a gas-liquid separator as a further component is needed to prevent that the leaked refrigerant travels in the heat medium circuit. Also, a gas purge valve is provided together with a gas-liquid separator. However, if a gas purge valve is arranged outside of a box and in the indoor space like FR 3070755A1 , there is also the risk of a refrigerant leaking into the indoor space at a welded part of the piping or at a connection from the degasser to the box.

To ensure a safe application of heat pumps and/or at least indoor units thereof inside indoor spaces, international standards, namely IEC60335-1 and IEC60335-2-40, and European standards, namely DIN EN 378-2 have been established. Therein, international rules for a charge limit of a leaked refrigerant in an indoor space are defined. This aims to avoid a flammable refrigerant concentration, especially in small indoor spaces.

### SUMMARY OF THE INVENTION

In view of the above, it is an object of the present disclosure to provide a more cost-effective indoor unit and a heat pump having a simple configuration, which reduces or prevents a leakage of refrigerant in an indoor space.

In other words, it is a key idea of the present disclosure to provide an improved indoor unit or heat pump configuration, which prevents a leakage of refrigerant in an indoor space.

This object is solved by an indoor unit according to claim 1 and by a heat pump according to claim 2. The dependent claims describe optional features and preferred embodiments.

According to a first aspect of the disclosure, an indoor unit for a heat pump is installed inside of a building. The indoor unit comprises a part of a heat medium circuit for circulating a heat medium, an intermediate heat exchanger to exchange heat between a refrigerant and the heat medium, a gas-liquid separator provided in the heat medium circuit, the gas-liquid separator comprising a gas purge valve to release refrigerant, a container accommodating the intermediate heat exchanger, the gas purge valve, and the gas-liquid separator, and a first duct provided at the container, the first duct communicating an inside of the container with an outdoor space for air exchange between the inside of the container and the outdoor space, wherein the outdoor space is outside of the building.

A possible refrigerant leakage of the refrigerant circuit into the heat medium circuit in the intermediate heat exchanger may cause a pressure increase in the heat medium circuit. For such a possible pressure increase in the heat medium circuit a countermeasure, such as the gas-liquid separator with a gas purge valve, is provided in the heat medium circuit. Thus, it is possible in case of a possible refrigerant leakage into the heat medium circuit that refrigerant can leak from the gas purge valve and that the leaked refrigerant is not transported in the heat medium piping. The container allows that in case of a possible leakage of refrigerant from a gas purge valve, the leaked refrigerant accumulates in the container and is transported through the first duct to the outdoor space. It is also possible that refrigerant may leak from piping connections or welded portions of the refrigerant piping. The refrigerant pipes may be covered by an insulation and a sealing material. The refrigerant pipes may be bent at angles between 20° and 90° and are thus vulnerable for leakage. The container allows also for the case of a leakage of refrigerant from the piping that the leaked refrigerant accumulates in the container and is transported through the first duct to the outdoor space.

Thus, by the indoor unit a possible flow of leaked refrigerant in the indoor space is prevented. Additionally, connections of the refrigerant piping with the intermediate heat exchanger or connections of the heat medium piping with the gas-liquid separator can be constructed simpler and may require a good sealing only. Thus, the indoor unit is provided with a simpler structure and less expensive.

An indoor unit according to a second aspect is the indoor unit of the first aspect, and the indoor unit further comprises a refrigerant leakage detector and the container further accommodates the refrigerant leakage detector. The refrigerant leakage detector may be connected with a control unit being configured to indicate to a user when a refrigerant leakage has occurred in the container.

The refrigerant leakage detector allows that in case of a leakage of refrigerant in the container, the leakage of refrigerant is detected.

An indoor unit according to a third aspect is the indoor unit of the first to second aspects, and the indoor unit further comprises a pressure relief valve provided in the heat medium circuit, and wherein the container further accommodates the pressure relief valve.

A high pressure in the heat medium is reduced due to the gas purge valve in the gas-liquid separator. However, if the pressure is still high after the gas purge valve, it might become necessary to provide a further countermeasure to prevent a high pressure in the heat medium circuit. Such a further countermeasure may be the pressure relief valve to release refrigerant and heat medium. The pressure relief valve may be an automatic pressure relief valve. Thus, it is possible that a high pressure in the heat medium circuit is reduced by the gas purge valve and the pressure relief valve. Simultaneously, the pressure might gradually or rapidly increase in the container. If heat medium and/or leaked refrigerant is released from the pressure relief valve, the heat medium and/or refrigerant accumulates in the container and is transported through the first duct to the outdoor space. Thus, it is possible to prevent a high pressure in the heat medium circuit and in the container due to leaked refrigerant and heat medium, and to prevent leaked refrigerant from entering the indoor space.

An indoor unit according to a fourth aspect is the indoor unit of the first to third aspects, wherein the container comprises an air intake configured to allow an air flow from an outside of the container in the inside of the container. The air intake may be provided on the front wall of the container. The air intake may be provided on a first side of the container and the first duct may be provided on a second side of the container, wherein the second side is different to the first t side. The air intake may allow an airflow from the indoor space into the container. The air intake may prevent an airflow from the container in the indoor space. The air intake may be opened mechanically due to an under pressure generated from the fan operation. An example of an air intake may be a shutter or a closing valve.

By the air intake it is possible that air enters the container from the indoor space. A negative pressure may be created in the container by air flowing from the container to the outdoor space. In the event of such a negative pressure in the container, air may enter the container through the air intake.

An indoor unit according to a fifth aspect is the indoor unit of the first to fourth aspects, wherein the gas refrigerant pipe and the liquid refrigerant pipe are disposed in the first duct. The liquid refrigerant pipe may be covered by an insulating material and the gas refrigerant pipe may be covered by an insulating material. The liquid refrigerant pipe and the gas refrigerant pipe may be covered together by an insulating material.

Due to the arrangement of the gas refrigerant pipe and the liquid refrigerant pipe in the first duct, it is possible that for an installation of the indoor unit only one breakthrough or opening in the house wall is required. Furthermore, by arranging the gas refrigerant pipe and the liquid refrigerant pipe in the first duct, where also natural ventilation of air is possible, a possible leaked refrigerant can flow to the outdoor space. Hence, a leakage of refrigerant in the indoor space is prevented. Furthermore, by arranging the liquid refrigerant pipe and the gas refrigerant pipe in the first duct, further additional sealings on the liquid refrigerant pipe and the gas refrigerant pipe are no longer necessary. Thus, a simpler and safer structure of the indoor unit is provided.

An indoor unit according to a sixth aspect is the indoor unit of the first to fourth aspects, wherein the indoor unit further comprises a second duct communicating the inside of the container with the outdoor space for air exchange between the inside of the container and the outdoor space. The liquid refrigerant pipe may be disposed in the first duct and the gas refrigerant pipe may be disposed in the second duct. Alternatively, the liquid refrigerant pipe and the gas refrigerant pipe may be disposed in the second duct. The second duct may be arranged at a lower position at the container than the first duct. The second duct may be arranged below the first duct. The second duct may comprise a drain pipe. The first duct and the second duct may be configured to discharge leaked refrigerant.

By the provision of a second duct, it is possible that a natural air ventilation can occur in the container. Air can enter the container through the first duct or second duct and can flow out of the container in the other one of the first duct or second duct. Thereby, a ventilation of the container to the outdoor space is provided and a refrigerant leakage into the indoor space is prevented. In the case that no refrigerant piping is provided in the first duct, the refrigerant may be exhausted easier and faster to the outdoor space. The weight of the refrigerant may be heavier than the weight of air. The accumulated leaked refrigerant liquid of the container may flow through the second duct to the outdoor space.

An indoor unit according to a seventh aspect is the indoor unit of the first to sixth aspects, wherein a ventilation duct is disposed in the first duct. A drain pipe may be disposed in the first duct. The drain pipe may be separated to the ventilation duct.

The ventilation duct may be a separate duct which is arranged in the first duct and allows an air flow from the container to the outdoor space. Supply air may inflow through the first duct in the container. Exhaust air may flow from the container through the ventilation duct to the outdoor space. By the provision of a ventilation duct, it is possible to ensure a minimum air flow rate in the container, so that a possible leaked refrigerant is transported to the outdoor space.

An indoor unit according to an eighth aspect is the indoor unit of the sixth or seventh aspect, further comprising a third duct communicating the inside of the container with the outdoor space for air exchange between the inside of the container and the outdoor space. The liquid refrigerant pipe may be disposed in the second duct and the gas refrigerant pipe may be disposed in the third duct. Alternatively, the liquid refrigerant pipe may be disposed in the third duct and the gas refrigerant pipe may be disposed in the second duct. The third duct may comprise a drain pipe.

By the provision of a third duct, it is possible that the refrigerant pipes of the refrigerant circuit are separately arranged and still a possible refrigerant leakage to the indoor space is prevented. Due to the separate arrangement of the refrigerant pipes, it is possible to arrange the refrigerant piping flexible and to reduce required piping lengths of the refrigerant pipes.

An indoor unit according to a ninth aspect is the indoor unit of the first to eighth aspects, wherein a fan is provided at an end of the first duct opening into the outdoor space, the fan being configured to generate an airflow from the inside of the container to the outdoor space through the first duct. The fan may be provided either in the container or at the first duct. The operation of the fan may create a lower pressure in the container. The fan may comprise a fan motor that is controlled by a control unit. The fan motor may be controlled by the refrigerant leakage detector. The fan motor may be operated by the controller if refrigerant is detected at the refrigerant leakage detector. The fan motor may be arranged at an outdoor space, so that the leaked refrigerant does not come into contact with the motor of the fan.

By the provision of a fan at an end of the first duct, an air flow is ensured. Due to the air flow created by the fan the container is ventilated so that no leaked refrigerant accumulates in the container and a possible high pressure in the container is prevented. Further, a leakage of refrigerant in the indoor space is prevented.

An indoor unit according to a tenth aspect is the indoor unit of the first to ninth aspects, wherein the inside of the container is hermetically sealed from the outside of the container.

In this context, hermetically sealed means that no gas or liquid can enter the container or can escape from the container in the indoor space, including any sealings used between the different components of the container. In other words, refrigerant inside the container should not leak from the container into the indoor space when a high pressure occurs in the container.

By the provision of a hermetically sealed container, it is further enhanced that no refrigerant may leak into the indoor space. Having a hermetically sealed container further increases the safety of the indoor unit using flammable refrigerant. The hermetically sealed container may further act as a gas-liquid accumulator and separator. In the hermetically sealed container, the leaked heat medium and refrigerant may accumulate and be separated into gas in the upper part and liquid at the bottom of the container. The accumulated leaked refrigerant may flow through the first duct to the outdoor space. The container may be airtight and ventilated by the first duct. In this context, airtight means that no air or gas can escape or pass through.

An indoor unit according to an eleventh aspect is the indoor unit of the first to tenth aspect, wherein the first duct and the second duct are arranged on one side of the container. Preferably the first duct and the second duct may be arranged on the top wall of the container. Alternatively, the first duct and the second duct may be arranged on the front wall, first side wall, second side wall, rear wall or bottom wall.

By the arrangement of the first duct and the second duct on one side of the container, the indoor unit is more compact, and the size of the indoor unit is reduced. The space required for the indoor unit in the indoor space is lower. The maintenance of the indoor unit is easier when the first duct and the second duct are arranged on the same side.

An indoor unit according to a twelfth aspect is the indoor unit of the first to eleventh aspects, wherein the container has a box shape with a first side wall and a second side wall, opposing the first side wall, a rear wall extending between the first side wall and the second side wall, a top wall being connected to upper ends of the first side wall, the second side wall, and the rear wall, a front wall opposing the rear wall, and a bottom wall opposing the top wall, wherein the first duct is provided at the top wall. Alternatively, the first duct may be provided at the first side wall, the second side wall, the front wall or the rear wall.

By the arrangement of the first duct at the top wall, the indoor unit is more compact and smaller in size. In addition, a maintenance of the indoor unit may be performed more easily by a maintenance person.

An indoor unit according to a thirteenth aspect is the indoor unit of the first to twelfth aspects, wherein the refrigerant leakage detector is arranged below the gas purge valve. The refrigerant leakage detector may be arranged below the gas-liquid separator. The refrigerant leakage detector may be arranged above the bottom wall of the container.

Due to the arrangement of the refrigerant leakage detector below the gas purge valve, it is possible to detect small amounts of leaked refrigerant in the container. By providing the refrigerant leakage detector above the bottom wall of the container, it is ensured that the refrigerant leakage detector does not come into contact with liquids that may accumulate on the bottom wall.

According to a fourteenth aspect of the disclosure, a heat pump comprising a refrigerant circuit for circulating a refrigerant comprising a liquid refrigerant pipe, a heat source heat exchanger, a compressor, an expansion valve, a gas refrigerant pipe, and an intermediate heat exchanger is provided. Further, the heat pump comprises a heat medium circuit for circulating a heat medium comprising a pump and the intermediate heat exchanger, the intermediate heat exchanger to exchange heat between the refrigerant and the heat medium, a gas-liquid separator provided in the heat medium circuit, the gas-liquid separator comprising a gas purge valve to release refrigerant, a container accommodating the intermediate heat exchanger, the gas purge valve, and the container, the first duct communicating an inside of the container with an outdoor space for air exchange between the inside of the container and the outdoor space, wherein the outdoor space is where the heat source heat exchanger and the compressor are located.

The heat pump allows that in case of a possible leakage of refrigerant, the leaked refrigerant accumulates in the container and is naturally transported through the first duct to the outdoor space. Thus, by the heat pump it is possible to prevent a refrigerant leak from the container into the indoor space.

The indoor unit according to a fifteenth aspect of the disclosure is the indoor unit for a heat pump installed inside of a building of the first aspect. The indoor unit according to the fifteenth aspect may also be different to the indoor unit of the first aspect. The indoor unit of the fifteenth aspect comprises the part of the heat medium circuit for circulating the heat medium, the intermediate heat exchanger to exchange heat between the refrigerant and the heat medium, a pressure relief valve to release the heat medium, which is provided in the heat medium circuit, the container accommodating the intermediate heat exchanger, and the pressure relief valve, wherein the container comprises the first duct and a second duct, wherein the first duct is connected to an upper part of the container and communicates an inside of the container with an outdoor space for air exchange between the inside of the container and the outdoor space, wherein the outdoor space is outside of the building, wherein the second duct is connected to a lower part of the container for drainage of liquid from the container. The pressure relief valve may be an automatic pressure relief valve.

A possible refrigerant leakage o the refrigerant circuit into the heat medium circuit in the intermediate heat exchanger may cause a pressure increase in the heat medium circuit. For such a possible pressure increase in the heat medium circuit a countermeasure, such as the pressure relief valve, is provided in the heat medium circuit. Thus, it is possible in case of a possible refrigerant leakage into the heat medium circuit and pressure increase in the heat medium circuit that heat medium can leak from the pressure relief valve and also refrigerant can leak from the pressure relief valve and that the leaked heat medium and refrigerant are not transported in the heat medium piping. The container allows that in case of a possible leakage of refrigerant and heat medium from a pressure relief valve, the leaked refrigerant and heat medium accumulate in the container and are transported through the first duct and/or second duct to the outdoor space. It is also possible that refrigerant may leak from piping connections or welded portions of the refrigerant piping in the container. The container allows also for the case of a leakage of refrigerant from the piping that the leaked refrigerant accumulates in the container. By the provision of a first duct and a second duct the accumulated leaked refrigerant and heat medium are transported from the container to the outdoor space. The leaked heat medium is in a liquid state and may flow through the second duct to the outdoor space. The leaked refrigerant may be in a gaseous state and may be exhausted through the first duct to the outdoor space.

Thus, by the indoor unit according to the fifteenth aspect a possible flow of leaked refrigerant in the indoor space is prevented. Additionally, connections of the refrigerant piping with the intermediate heat exchanger or connections of the heat medium piping with the gas-liquid separator can be constructed simpler and may require a good sealing only. Thus, the indoor unit is provided with a simpler structure and less expensive. Also, since the heat medium and refrigerant are exhausted to the outdoor space via their respective ducts, the heat medium and refrigerant can be effectively exhausted from inside the container to the outdoor space.

An indoor unit according to a sixteenth aspect is the indoor unit of the fifteenth aspect, wherein the second duct communicates the inside of the container with the outdoor space for air exchange between the inside of the container and the outdoor space.

The second duct also allows that air is supplied through the second duct into the container and that air is exhausted through the first duct to the outdoor space. Thereby a good ventilation of the container is achieved.

An indoor unit according to a seventeenth aspect is the indoor unit of the fifteenth or sixteenth aspect, wherein the container has a box shape with a first side wall and a second side wall, opposing the first side wall, rear wall extending between the first side wall and the second side wall, a top wall being connected to upper ends of the first side wall, the second side wall, and the rear wall, a front wall opposing the rear wall, and a bottom wall opposing the top wall, wherein the first duct is arranged at the top wall of the container, and wherein the second duct is arranged at the rear wall or at the bottom wall of the container. Alternatively, the first duct may be provided at the first side wall, the second side wall, the front wall or the rear wall. Alternatively, the second duct may be provided at the first side wall, the second side wall, the front wall or the top wall.

By the arrangement of the first duct at the top wall and the second duct at the rear wall or bottom wall, the indoor unit is more compact and smaller in size. In addition, a leakage of refrigerant in the indoor space is prevented by the ventilation of the container so that a low concentration of leaked refrigerant is ensured in the container.

An indoor unit according to an eighteenth aspect is the indoor unit of the seventeenth aspect, wherein the bottom wall of the container is inclined towards an opening of the second duct. The bottom wall of the container may be inclined so that a liquid flows towards an opening of the second duct. By the provision of an inclination in the bottom wall, it is ensured that a liquid can drain from the container. Thus, a low concentration of leaked refrigerant and heat medium in the container can be maintained and a leakage of refrigerant in the indoor space is prevented.

An indoor unit according to a nineteenth aspect is the indoor unit of the fifteenth to eighteenth aspects, wherein the second duct is arranged at a lowest position of the container. The second duct may be arranged at a lowest position of the container in the rear wall. The second duct may be arranged at the lowest position of the container in the bottom wall. Due to the position of the second duct at the lowest position of the container it is ensured that the accumulated liquid can drain from the container. A low concentration of leaked refrigerant in the container can be maintained due to the drainage of liquid from the container and a leakage of refrigerant in the indoor space is prevented.

An indoor unit according to a twenties aspect is the indoor unit of the fifteenth to nineteenth aspects, wherein the first duct is configured to discharge air from the inside of the container to the outdoor space and the second duct is configured to allow an air inflow from the outdoor space to the inside of the container, or wherein the first duct is configured to allow an air inflow from the outdoor space to the inside of the container and the second duct is configured to discharge air from the inside of the container to the outdoor space. By providing a first duct and a second duct natural ventilation of the container is ensured, so that a low concentration of leaked refrigerant can be maintained in the container and a leakage of refrigerant in the indoor space from the container is prevented.

An indoor unit according to a further aspect is the indoor unit of the fifteenth to sixteenth aspects, wherein a gas-liquid separator is provided in the heat medium circuit, the gas-liquid separator comprising a gas purge valve to release refrigerant, and wherein the container further accommodates the gas-liquid separator and the gas purge valve.

A possible high pressure in the heat medium is reduced due to the pressure relief valve. However, to prevent that the pressure is still high after the pressure relief valve, it might become necessary to provide a further countermeasure to prevent a high pressure in the heat medium circuit. Such a further countermeasure may be the gas-liquid separator comprising a gas purge valve to release refrigerant. Thus, it is possible that a high pressure in the heat medium circuit is reduced by the gas purge valve and the pressure relief valve. Simultaneously, the pressure might gradually or rapidly increase in the container. If heat medium and/or leaked refrigerant is released from the pressure relief valve and the gas purge valve, the heat medium and/or refrigerant accumulates in the container. By the provision of the first duct and the second duct the accumulated leaked gas and liquid are transported to the outdoor space. Thus, it is possible to prevent a high pressure in the heat medium circuit and in the container due to leaked refrigerant and heat medium, and to prevent leaked refrigerant from entering the indoor space.

An indoor unit according to a further aspect is the indoor unit of the fifteenth to sixteenth aspects, wherein the container comprises an air intake configured to allow an airflow from outside the container in the inside of the container.

The air intake may be provided on the front wall of the container. The air intake may be provided on a first side of the container and the first duct may be provided on a second side of the container, wherein the second side is different to the first side. The air intake may allow an airflow from the indoor space into the container. The air intake may prevent an airflow from the container in the indoor space. The air intake may be opened mechanically due to an under pressure generated from the fan operation. An example of an air intake may be a shutter or a closing valve.

By the air intake it is possible that air enters the container from the indoor space. A negative pressure may be created in the container by air flowing from the container to the outdoor space. In the event of such a negative pressure in the container, air may enter the container through the air intake.

The indoor unit may further comprise a fan, wherein the fan is arranged at an outdoor end of the first duct, the fan being configured to generate an airflow from the inside of the container to the outdoor space through the first duct.

The fan may be provided either in the container, at the first duct or at the second duct. When the fan is operated, supply air flows in the second duct in the container and exhaust air flows in the first duct to the outdoor space. The operation of the fan may create a lower pressure in the container. The fan may comprise a fan motor that is controlled by a control unit. The fan motor may be controlled by the refrigerant leakage detector. The fan motor may be operated by the control unit if refrigerant is detected at the refrigerant leakage detector. The fan motor may be arranged at an outdoor space, so that the leaked refrigerant and heat medium do not come into contact with the motor of the fan.

By the provision of a fan at an end of the first duct, an air flow is ensured. Due to the air flow created by the fan the container is ventilated so that no leaked refrigerant accumulates in the container and a possible high pressure in the container is prevented. Further, a leakage of refrigerant in the indoor space is prevented.

In the indoor unit, the inside of the container may be hermetically sealed from the outside of the container. Also, by the provision of a fan at an end of the first duct and by the provision of the drainage through the second duct, the fan can be prevented from getting wet by a drained liquid, because the drainage of liquid is exhausted through the second duct.

In this context, hermetically sealed means that no gas or liquid can enter the container or can escape from the container in the indoor space, including any sealings used between the different components of the container. In other words, refrigerant inside the container should not leak from the container into the indoor space when a high pressure occurs in the container.

By the provision of a hermetically sealed container, it is further enhanced that no refrigerant may leak into the indoor space. Having a hermetically sealed container further increases the safety of the indoor unit using flammable refrigerant. The hermetically sealed container may further act as a gas-liquid accumulator and separator. In the hermetically sealed container, the leaked heat medium and refrigerant may accumulate and be separated into gas in the upper part and liquid at the bottom of the container. The accumulated leaked refrigerant may flow through the first duct to the outdoor space and the accumulated heat medium may flow through the second duct to the outdoor space. The container may be airtight and ventilated by the first duct and/or second duct. In this context, airtight means that no air or gas can escape or pass through.

In the indoor unit, the gas refrigerant pipe and the liquid refrigerant pipe may be disposed in the first duct or in the second duct. The liquid refrigerant pipe may be covered by an insulating material and the gas refrigerant pipe may be covered by an insulating material. The liquid refrigerant pipe and the gas refrigerant pipe may be covered together by an insulating material.

Due to the arrangement of the gas refrigerant pipe and the liquid refrigerant pipe in the first duct or in the second duct, a possible leaked refrigerant can flow to the outdoor space. By providing the liquid refrigerant pipe and the gas refrigerant pipe together in the second duct, a better ventilation of air is possible through the first duct. Hence, a leakage of refrigerant in the indoor space is prevented. Furthermore, by arranging the liquid refrigerant pipe and the gas refrigerant pipe in the first duct or second duct, further additional sealings on the liquid refrigerant pipe and the gas refrigerant pipe are no longer necessary. Thus, a simpler and safer structure of the indoor unit is provided.

The indoor unit according to a further aspect, wherein the container may further comprise a detachable lid. The top wall of the container may comprise the detachable lid. The detachable lid may be arranged on the first side wall, the second side wall, or the front wall. The detachable lid may allow the maintenance person to open the container for inspection and service. The detachable lid may be made of a sheet metal or plastic material. A sealing may be provided between the detachable lid and the container.

The indoor unit may further comprise a refrigerant leakage detector and the container may further accommodate the refrigerant leakage detector. The refrigerant leakage detector may be connected with a control unit being configured to indicate to a user when a refrigerant leakage has occurred in the container. The fan may comprise a fan motor that is controlled by a control unit. The fan motor may be controlled by the refrigerant leakage detector. The fan motor may be operated by the control unit if refrigerant is detected at the refrigerant leakage detector.

The refrigerant leakage detector allows that in case of a leakage of refrigerant in the container, the leakage of refrigerant is detected.

The refrigerant leakage detector may be arranged below the gas purge valve and/or the pressure relief valve. The refrigerant leakage detector may be arranged below the gas-liquid separator. The refrigerant leakage detector may be arranged above the bottom wall of the container.

Due to the arrangement of the refrigerant leakage detector below the gas purge valve and/or the pressure relief valve, it is possible to detect small amounts of leaked refrigerant in the container. By providing the refrigerant leakage detector above the bottom wall of the container, it is ensured that the refrigerant leakage detector does not come into contact with liquids that may accumulate on the bottom wall.

The indoor unit according to a further aspect, wherein the first duct may be connected to a first side of the container and the air intake may be connected to a second side of the container and the first side is different to the second side.

By providing the air intake on a different side to the first duct, it is possible that the airflow from the air intake flows through the container to the first duct and ensures a good ventilation of the container. Thus, a low concentration of leaked refrigerant is ensured in the container and a leakage of refrigerant into the indoor space is prevented.

According to a further aspect of the disclosure, a heat pump comprising refrigerant circuit for circulating a refrigerant comprising a liquid refrigerant pipe, a heat source heat exchanger, a compressor, an expansion valve, a gas refrigerant pipe, and an intermediate heat exchanger is provided. Further, the heat pump comprises a heat medium circuit for circulating a heat medium comprising a pump and the intermediate heat exchanger, the intermediate heat exchanger to exchange heat between the refrigerant and the heat medium, a pressure relief valve to release the heat medium, which is provided in the heat medium circuit, a container accommodating the intermediate heat exchanger, and the pressure relief valve, wherein the container comprises a first duct and a second duct, wherein the first duct is connected to an upper part of the container and communicates an inside of the container with an outdoor space for air exchange between the inside of the container and the outdoor space, wherein the outdoor space is where the heat source heat exchanger and the compressor are located, wherein the second duct is connected to a lower part of the container for drainage of liquid from the container.

The heat pump allows that in case of a possible leakage of refrigerant, the leaked refrigerant accumulates in the container and is naturally transported through the first duct and/or second duct to the outdoor space. Thus, by the heat pump it is possible to prevent a leak of refrigerant from the container into the indoor space.

The indoor unit of the fifteenth aspect may be installed in the heat pump of the previous aspect. The heat pump is compatible with all aspects of the indoor unit. The features described above for the indoor unit of the disclosure also apply to the heat pump of the disclosure. The heat pump of the disclosure provides the technical effects and advantages already described in detail above for the indoor unit of the disclosure. In particular, the heat pump enables that a possible flow of leaked refrigerant in the indoor space is prevented.

The heat pump may be an air heat pump using air as a heat source or a ground source heat pump using the ground as a heat source. The heat pump may be used for producing domestic hot water, air conditioning (heating and/or cooling) and the like. In an air heat pump, an outdoor unit may be provided which comprise the compressor, the expansion valve and the heat source heat exchanger of the refrigerant circuit. The outdoor unit may be disposed outdoors. The indoor unit may be configured to be arranged in an indoor space comprising a heat exchanger unit.

Even further, the heat pump may be an enhanced tightness refrigerating system. An ‘enhanced tightness refrigerating system’ is a system in which the indoor unit is designed and fabricated to ensure a high level of confidence that large refrigerant leak rates will not occur in normal and abnormal operation.

The indoor unit of the first aspect may be installed in the heat pump of the fourteenth aspect. The heat pump of the fourteenth aspect is compatible with the first to thirteenth aspects of the indoor unit. The features described above for the indoor unit of the disclosure also apply to the heat pump of the disclosure. The heat pump of the disclosure provides the technical effects and advantages already described in detail above for the indoor unit of the disclosure. In particular, the heat pump enables that a possible flow of leaked refrigerant in the indoor space is prevented.

The heat pump may be an air heat pump using air as a heat source or a ground source heat pump using the ground as a heat source. The heat pump may be used for producing domestic hot water, air conditioning (heating and/or cooling) and the like. In an air heat pump, an outdoor unit may be provided which comprise the compressor, the expansion valve and the heat source heat exchanger of the refrigerant circuit. The outdoor unit may be disposed outdoors. The indoor unit may be configured to be arranged in an indoor space comprising a heat exchanger unit.

Even further, the heat pump may be an enhanced tightness refrigerating system. An ‘enhanced tightness refrigerating system’ is a system in which the indoor unit is designed and fabricated to ensure a high level of confidence that large refrigerant leak rates will not occur in normal and abnormal operation.

The ‘duct’ is to be understood as a rigid or flexible pipe. The duct may be a tube. Alternatively, the duct may be made up 4 several parts that are fluidly, such as airtightly, connected. The duct may comprise a plurality of sections that are in fluid connection with each other. At least one section of the duct may be flexible. Using a plurality of sections improves the constructional flexibility, as the container can be arranged at different positions in the indoor space. The duct may be made of a plastic material, for example of polyvinyl chloride, or of a metal. The duct may comprise a cover at the end that faces the outdoor space. The cover may protect the duct from any kind of pollution. The first duct may be an air inlet and/or an air outlet. The second duct may be an air inlet and/or an air outlet. The second duct may be an air inlet and a liquid outlet. The third duct may be an air inlet and a liquid outlet.

In an embodiment, the duct may extend from the container in the indoor space through a housing wall to the outdoor space. The first duct and/or second duct may be arranged within a breakthrough in the house wall or in an opening in the house wall.

The heat pump may heat water (one example of a use-side fluid) supplied to a target space to heat the target space. The heat pump may include an outdoor unit disposed at an outdoor space, a heat exchanger unit and an indoor unit installed in the indoor space. The outdoor unit and the heat exchanger unit may be connected to each other by refrigerant piping, including a liquid refrigerant pipe and a gas refrigerant pipe. The heat exchanger unit and the indoor unit may be connected to each other by heat medium piping. The refrigerant circuit and the heat medium circuit may be constituted in the heat pump.

The heat medium circuit may include at least an intermediate heat exchanger, a first heat medium pipe, a second heat medium pipe, a gas-liquid separator with a gas purge valve, a pressure relief valve, and a pump. The heat medium circuit may be filled with a heat medium (one example is water) that circulates to achieve a heat medium cycle. The heat medium circuit may be for circulating a heat medium comprising the intermediate heat exchanger.

The refrigerant circuit may comprise at least a compressor, a heat source heat exchanger (e. g., outdoor air heat exchanger or ground source heat exchanger), an expansion valve (one example of an expansion mechanism), an intermediate heat exchanger, a liquid refrigerant pipe, and a gas refrigerant pipe. All elements may be connected by a refrigerant piping, such that refrigerant can flow from one component to the other and can achieve heat exchange with a heat medium. The refrigerant circuit may be configured to circulate a refrigerant. The refrigerant circuit may be filled with a refrigerant that circulates to achieve a refrigeration cycle. The refrigerant may, for example, be R290, R744, or the like. The refrigerant may be a flammable refrigerant. The refrigerant may include propane or carbon dioxide.

A ‘flammable refrigerant’ is to be understood as having a density higher than air under atmospheric pressure. ‘Flammable refrigerant’ may be refrigerant classified as class A2L, A2 or A3 according to ISO 817.

The outdoor unit may comprise an outdoor unit casing that is disposed at an outdoor space. The outdoor unit casing may accommodate the compressor, the heat source heat exchanger, the expansion valve, a part of the liquid refrigerant pipe, and a part of the gas refrigerant pipe.

The indoor unit may comprise the heat exchanger unit. The heat exchanger unit may comprise a container. The indoor unit may comprise an indoor unit casing and a container. The container may be separate to the indoor unit casing.

The heat exchanger unit for a heat pump may be installed inside of a building. The heat exchanger unit may comprise a container that is disposed in an indoor space. The heat exchanger unit may comprise a part of the heat medium circuit for circulating a heat medium, the intermediate heat exchanger to exchange heat between a refrigerant and the heat medium, the gas-liquid separator provided in the heat medium circuit, and the container. The heat exchanger unit may further comprise a part of the refrigerant circuit for circulating a refrigerant. The intermediate heat exchanger may exchange heat between the refrigerant and the heat medium. The heat medium circuit may be filled with a heat medium (one example is water) that circulates to achieve a heat medium cycle. The heat medium circuit may be for circulating a heat medium comprising the intermediate heat exchanger. The gas-liquid separator may comprise the gas purge valve to release refrigerant. The gas-liquid separator may separate gas and liquid. The gas-liquid separator may be arranged on n a downstream side of the intermediate heat exchanger. The downstream side of the intermediate heat exchanger is the side of the intermediate heat exchanger on which the heat medium flows away from the intermediate heat exchanger. The gas purge valve may be arranged at the upper most portion of the gas-liquid separator to release the separated gas. The container may further accommodate the pressure relief valve. The pressure relief valve may be arranged on a downstream side of the gas-liquid separator. The downstream side of the gas-liquid separator is the side of the gas-liquid separator on which the heat medium flows away from the gas-liquid separator. The gas purge valve and the pressure relief valve may be provided in the heat medium circuit.

The container may further accommodate a part of the liquid refrigerant pipe and the gas refrigerant pipe, and a part of the heat medium piping. The container may accommodate the connection of the liquid refrigerant pipe with the intermediate heat exchanger and the connection of the gas refrigerant pipe with the intermediate heat exchanger. The container may accommodate the connection of the heat medium piping with the intermediate heat exchanger. The container may accommodate the connection of the heat medium piping with the gas-liquid separator. The container may not comprise an ignition source such as electronic components which generate heat. The container may accommodate leaked refrigerant. The container may accommodate released heat medium that has been released at the pressure relief valve. The container may accommodate any released gas or liquid from the gas purge valve and/or the pressure relief valve. At the bottom of the container liquid heat medium may accumulate. In other words, accumulated liquid may be leaked heat medium.

The top wall may be connected to the first side wall, the second side wall, the rear wall and the front wall by connecting elements (one example may be screws that are fixed by bolds) and may optionally further comprise sealing elements (an example may be a rubber seal or a sealing made of a plastic material).

Furthermore, the container may comprise a detachable lid, which is preferably arranged on the top wall. The detachable lid may be arranged on the first side wall, the second side wall, or the front wall. The detachable lid may allow the maintenance person to open the container for inspection and service.

The top wall of the container may comprise an outer duct connection, a first inner duct connection, and a second inner duct connection. The outer duct connection may be configured to receive the first duct. The first inner duct connection may be configured to receive the first duct. The second inner duct connection may be configured to receive the second duct. By the provision of the outer duct connection, the first inner duct connection, and a second inner duct connection, the container is versatile and can be used for the different application, where only a first duct is provided or where a first duct and second duct are provided. Thus, a simple and versatile configuration of the indoor unit is achieved.

The container may withstand an internal pressure build up of 4.5 time of the ambient pressure. The ambient pressure is the pressure of the indoor space. The container may be made from a plastic material, such as acrylonitrile styrene acrylate or similar. The detachable lid may be made of a sheet metal or a plastic material. A sealing may be provided between the detachable lid and the container.

### BRIEF DESCRIPTION OF THE DRAWINGS

FIG. 1 is a piping diagram depicting a configuration of a refrigerant circuit and heat medium circuit in a heat pump according to an embodiment of the present disclosure.

FIG. 2 is a schematic view illustrating the container with a first duct of a first embodiment of the present disclosure.

FIG. 3 is a schematic view illustrating the container with a first duct and a second duct of the second embodiment of the present disclosure.

FIG. 4 is a schematic view illustrating the container of with a first duct of the first modification of the first embodiment of the present disclosure.

FIG. 5 is a schematic view illustrating the container with a first duct and a second duct of the first modification of the second embodiment of the present disclosure.

FIG. 6 is a schematic view illustrating the container with a first duct, a second duct and a third duct of a third embodiment of the present disclosure.

FIG. 7 is a perspective view from below of the container according to the first embodiment.

FIG. 8 is a perspective view from above of the container according to the first embodiment.

FIG. 9 is a perspective view from the side of the container according to the first embodiment.

FIG. 10 is a perspective view from the front of the container according to the first embodiment.

FIG. 11 is a perspective view from the side of the container according to the second embodiment.

FIG. 12 is a perspective view from above of the container according to the second embodiment.

FIG. 13 is a perspective view from the rear of the container according to the third embodiment.

FIG. 14 is a schematic view illustrating the container with a first duct and a second duct of a fourth embodiment of the present disclosure.

### DESCRIPTION OF EMBODIMENTS

Hereinafter, embodiments according to the disclosure will be described in detail with reference to the accompanying drawings in order to describe the disclosure using illustrative examples. Further modifications of certain individual features described in this context can be combined with other features of the described embodiments to form further embodiments of the disclosure. Throughout the drawings, the same reference numerals are used for the same or similar elements.

Description is made herein to a heat pump 1 as an exemplary refrigeration apparatus.

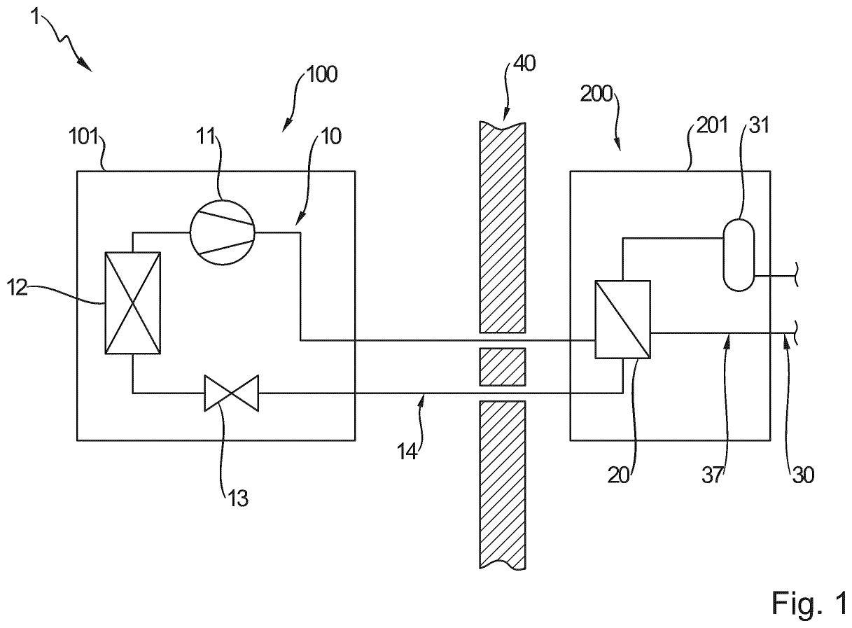

FIG. 1 is a piping diagram depicting a configuration of a refrigerant circuit 10 and heat medium circuit 30 in a heat pump 1 according to an embodiment of the present disclosure. The heat pump 1 heats water (one example of a use-side fluid) supplied to a target space (not illustrated) to heat the target space. As illustrated in FIG. 1, the heat pump 1 includes an outdoor unit 100 disposed at an outdoor space, a heat exchanger unit 200 and an indoor unit 300 (not illustrated) installed in the indoor space. The outdoor unit 100 and the heat exchanger unit 200 are connected to each other by the refrigerant piping 14. The heat exchanger unit 200 and the indoor unit 300 (not illustrated) are connected to each other by the heat medium piping 37. The refrigerant circuit 10 and the heat medium circuit 30 are accordingly constituted in the heat pump 1.

The heat medium circuit 30 includes at least an intermediate heat exchanger 20, a first heat medium pipe 37, a second heat medium pipe 37, a gas-liquid separator 31 with a gas purge valve 313, a pressure relief valve 314 (not illustrated), and a pump 36 (not illustrated). The heat medium circuit 30 is filled with a heat medium (one example is water) that circulates to achieve a heat medium cycle. The heat medium circuit 30 is for circulating a heat medium comprising the intermediate heat exchanger 20.

The refrigerant circuit 10 used in the heat pump of the present disclosure corresponds to a commonly known refrigerant circuit, which comprises at least a compressor 11, a heat source heat exchanger 12 (e.g., outdoor air heat exchanger or ground source heat exchanger), an expansion valve 13 (one example of an expansion mechanism), an intermediate heat exchanger 20, a liquid refrigerant pipe 142, and a gas refrigerant pipe 143. All elements are connected by a refrigerant piping, such that refrigerant can flow from one component to the other and can achieve heat exchange with a heat medium. The refrigerant circuit 10 is filled with a refrigerant that circulates to achieve a refrigeration cycle. The refrigerant circuit 10 is configured to circulate a refrigerant. Refrigerant used in the exemplary embodiments of the present disclosure consists of R290 or R744. Usually, R290 and R744 comprise a higher density than air under atmospheric pressure. Thus, R290 R744 usually concentrates at bottom sections of spaces or volumes. The refrigerant piping 14 may be covered by an insulation and a sealing material. The refrigerant piping 14 may be bent at angles between 20° and 90° and are thus vulnerable for leakage.

The outdoor unit 100, as illustrated in FIG. 1, comprises an outdoor unit casing 101 that is disposed at an outdoor space. The outdoor unit casing 101 accommodates the compressor 11, the heat source heat exchanger 12, the expansion valve 13, and a part of the liquid refrigerant pipe 142 and the gas refrigerant pipe 143.

The indoor unit 300 comprises an indoor unit casing (not illustrated) that is dispose in the indoor space. The indoor unit casing accommodates the pump 36, and a part of the heat medium piping 37. The indoor unit casing (not illustrated) further includes a machine chamber part and a tank chamber part, wherein the tank chamber part may further include a hot water tank and a coil.

The indoor unit 300 further comprises the heat exchanger unit 200. The heat exchanger unit 200 comprises a container 201 and especially the container 201 may be separate to the indoor unit casing. The indoor unit 300 comprises an indoor unit casing and a container 201.

The heat exchanger unit 200, as illustrated in FIG. 1, for a heat pump 1 is installed inside of a building. The heat exchanger unit 200 comprises a container 201 that is disposed in an indoor space. The heat exchanger unit 200 comprises a part of the heat medium circuit 30 for circulating a heat medium, the intermediate heat exchanger 20 to exchange heat between a refrigerant and the heat medium, the gas-liquid separator 31 provided in the heat medium circuit, and the container 201. The container 201 accommodates the intermediate heat exchanger 20, the gas purge valve 313, and the gas-liquid separator 31. The gas-liquid separator 31 comprises the gas purge valve 313 to release refrigerant. The container 201 also accommodates the pressure relief valve 314. The container 201 further accommodates a part of the liquid refrigerant pipe 142 and the gas refrigerant pipe 143, and a part of the heat medium piping 37.

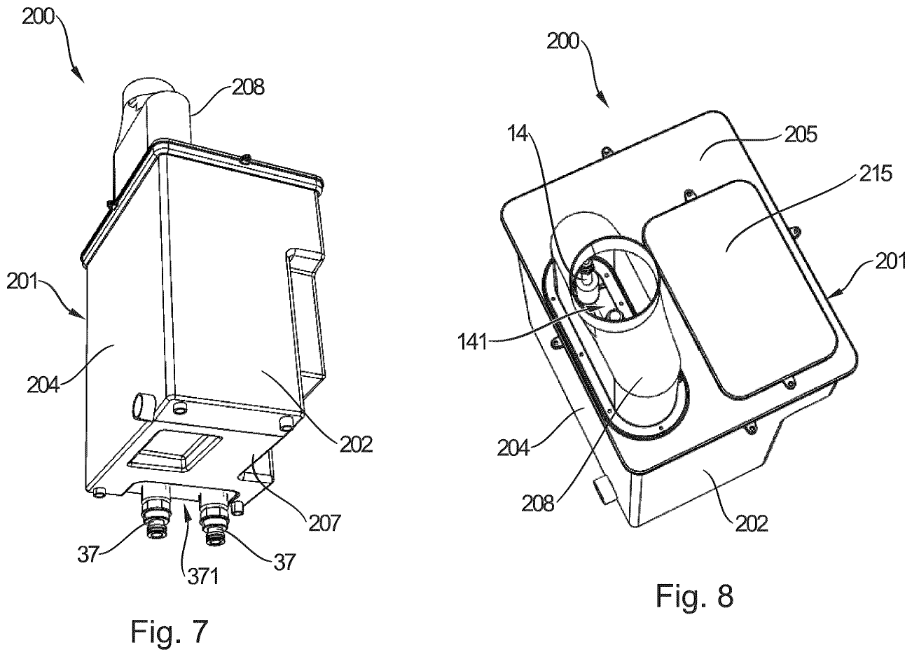

FIG. 7 and FIG. 8 show a container 201 of the heat exchanger unit 200 of the embodiment as illustrated in FIG. 1. The container 201 has a box shape with a first side wall 202 and a second side wall 203, opposing the first side wall 202, a rear wall 204 extending between the first side wall 202 and the second side wall 203, a top wall 205 being connected to upper ends of the first side wall 202, the second side wall 203, and the rear wall 204, a front wall 206 opposing the rear wall 204, and a bottom wall 207 opposing the top wall 205. The container 201 may comprise a detachable lid 215, which is preferably arranged on the top wall 205.

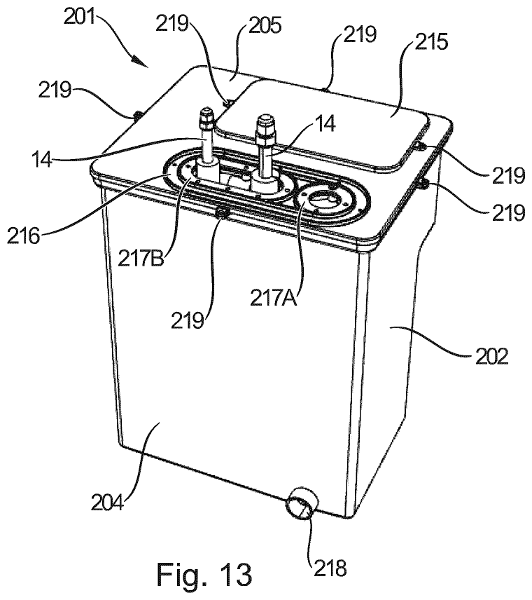

FIG. 13 shows a perspective view from the rear of the container 201 of the third embodiment. The container 201 of the third embodiment may be the same container of the first and second embodiment. The top wall 205 may comprise a detachable lid 215, an outer duct connection 216, a first inner duct connection 217A, and a second inner duct connection 217B. The outer duct connection 216 is configured to receive the first duct 208 of the first embodiment. The first inner duct connection 217A is configured to receive the first duct 208 of the second embodiment, and the second inner duct connection 217B is configured to receive the second duct 209 of the second embodiment. The container 201 may further comprise a third duct connection 218 in the rear wall 204. The third duct connection 218 may be arranged in the lowest part of the container 201. The third duct connection 218 may be arranged in the bottom wall 207 of the container 201. The third duct connection 218 is configured to receive the third duct 213. The third duct 213 may be attached to the third duct connection 218.

The container 201 of the first to third embodiments may further comprise an air intake 210 configured to allow an air flow from an outside of the container 201 in the inside of the container 201 (FIG. 10). The air intake 210 is preferably provided on the front wall in a lower portion of the container. The first duct 208 is connected to a first side of the container and the air intake 210 is connected to a second side of the container and the first side is different to the second side. The first duct 208 is connected to the top wall 205 and the air intake 210 is provided in a lower portion of the front wall, so that a ventilation of the container 201 is achieved. The inside of the container 201 is hermetically sealed from the outside of the container 201. Preferably, the top wall 205 is connected to the first side wall 202, the second side wall 203, the rear wall 204 and the front wall 206 by connecting elements 219 (one example is screws that are fixed by bolts).

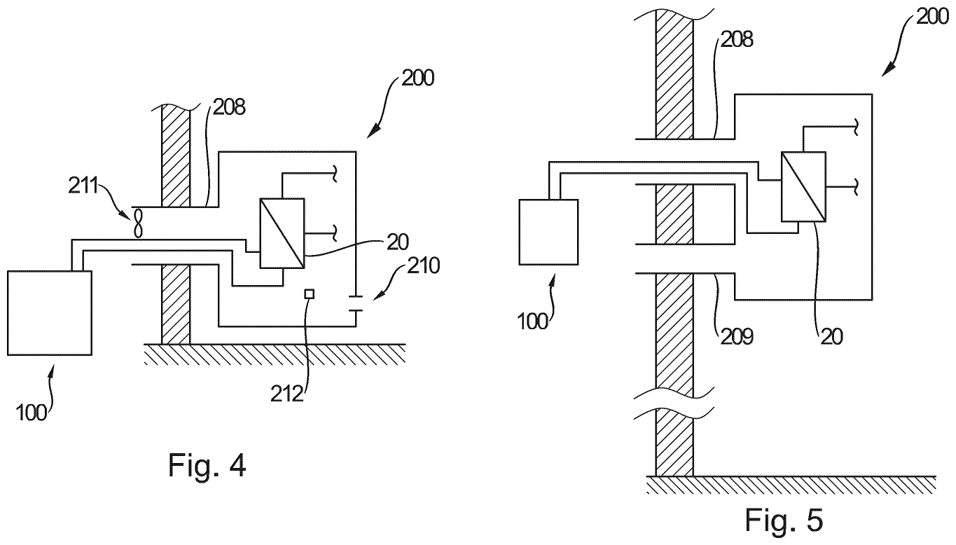

The container 201 further comprises a refrigerant leakage detector 212 and the container 201 may further accommodate the refrigerant leakage detector 212. The refrigerant leakage detector 212 is preferably arranged in a lower half of the container 201, as illustrated in FIG. 3 and FIG. 4. The refrigerant leakage detector 212 may be arranged below the gas purge valve 313. The refrigerant leakage detector 212 may be configured to control a motor of a fan 211, which is provided at the end of the first duct 208 which opens into the outdoor space. The fan 211 is configured to generate an airflow from the inside of the container 201 to the outdoor space through the first duct 208.

The indoor space is separate from the outdoor space and may be separated by a house wall 40. The house wall may comprise one opening, two openings or three openings. The opening of the house wall 40 may be a breakthrough in the house wall and may receive a duct of the heat exchanger unit 200.

Further commonly known elements of an indoor unit, such as a magnetic filter, a control unit, a three-way-valve, a flow sensor, an expansion vessel, a pressure sensor, a backup heater, a connection terminal, a switch box, a user interface, a circulation pump, etc. are not relevant for the description of the exemplary embodiments and are well known to a skilled person, such that a further description thereof will be omitted. Accordingly, some of the elements are also not illustrated in the drawings for orientation purposes.

Subsequently, several embodiments of the heat pump 1 of the present disclosure will be described in detail.

### First Embodiment

Next, the heat exchanger unit 200 of a first embodiment will be described with reference to FIGS. 1, 2, 7, 8, 9, and 10. The first embodiment uses the heat pump 1 as previously described, and as illustrated in FIG. 1. Thus, the description of similar elements than the ones of the previously described will be omitted. The first embodiment comprises a heat pump with a first duct.

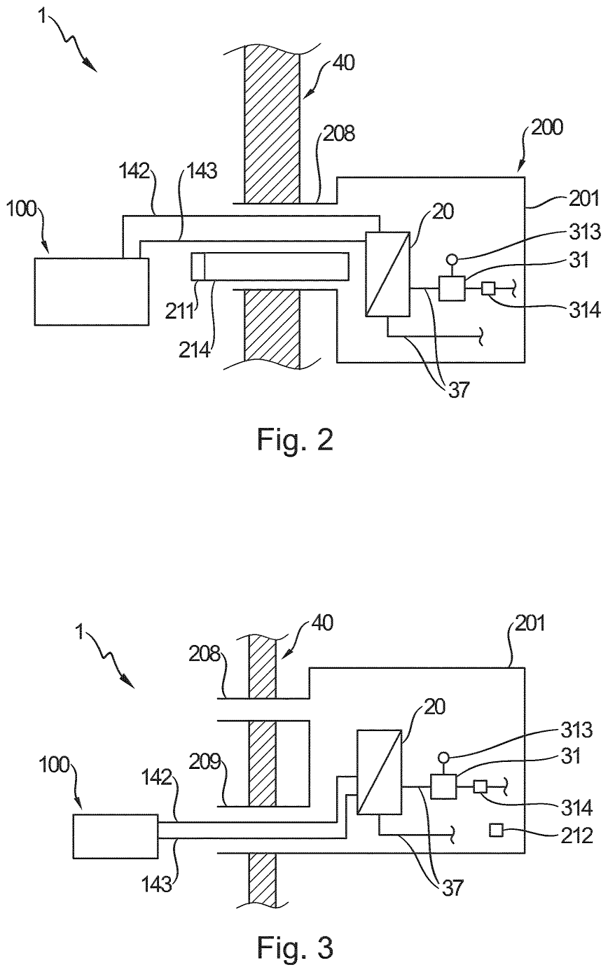

FIG. 2 is a schematic view illustrating the container 201 with a first duct 208 of a first embodiment of the present disclosure. In the heat exchanger unit 200 of the first embodiment of the heat pump 1, the container 201 comprises a first duct 208. The first duct 208 is arranged in an opening in the house wall 40. The first duct 208 is provided at the container 201, especially at the top wall 205 of the container 201. Alternatively, the first duct 208 may be provided at the rear wall 204 of the container 201. The first duct 208 has a first end that is arranged at the container 201 and a second end that is arranged in the house wall 40 and extends towards the outdoor space, where the outdoor unit 100 is situated. The first duct 208 communicate an inside of the container 201 with an outdoor space for air exchange between the inside of the container 201 and the outdoor space. The outdoor space is outside of the building, where the outdoor unit 100 is situated.

In the first duct 208, the gas refrigerant pipe 143 and the liquid refrigerant pipe 142 are disposed. A ventilation duct 214 is further disposed in the first duct 208. The ventilation duct 214 is a tube. A fan 211 is provided at an end of the first duct 208 opening into the outdoor space. The fan 211 is configured to create an airflow through the first duct 208 from the inside of the container 201 to the outdoor space. As illustrated in FIG. 2, the fan 211 can be preferably provided at an end of the ventilation duct 214 opening into the outdoor space. Accordingly, possible leaked refrigerant of the container is transported by the airflow through the first duct to the outdoor space.

The container 201 accommodates the intermediate heat exchanger 20, the gas purge valve 313, the gas-liquid separator 31, the pressure relief valve 314, parts of the heat medium piping 37, and parts of the refrigerant piping 14. The refrigerant piping 14 comprises the liquid refrigerant pipe 142 and the gas refrigerant pipe 143. Additionally, the connections of the refrigerant piping 14 with the intermediate heat exchanger 20 are accommodated in the container 201. The gas purge valve 313 and the pressure relief valve 314 which are likely sources of refrigerant leakage are accommodated in the container 201. Accordingly, a possible refrigerant leakage of the refrigerant piping 14 or of the components of the heat medium circuit 30 and refrigerant circuit 10 can be accumulated in the container 201 and a refrigerant leakage into the indoor space is prevented.

FIG. 7 is a perspective view from below of the container 201 according to the first embodiment and FIG. 8 is a perspective view from above of the container 201 according to the first embodiment. The heat exchanger unit 200 comprises a container 201 and the first duct 208. The first duct 208 is provided at the container 201. The container 201 further comprises a rear wall 204, a first side wall 202, a second side wall 203, a top wall 205, and a bottom wall 207. At the bottom wall 207, a heat medium pipe connection point 371 is provided for connecting the heat medium piping 37. The heat medium piping 37 includes a first heating medium piping 37 and a second heat medium piping 37. As illustrated in FIG. 8, the first duct 208 is provided at the top wall 205. In the first duct 208, the refrigerant pipe connection point 141 is arranged for connecting the refrigerant piping 14. When the refrigerant piping 14 is connected at the refrigerant pipe connection point 141 with the intermediate heat exchanger, the refrigerant piping 14 is arranged in the first duct 208.

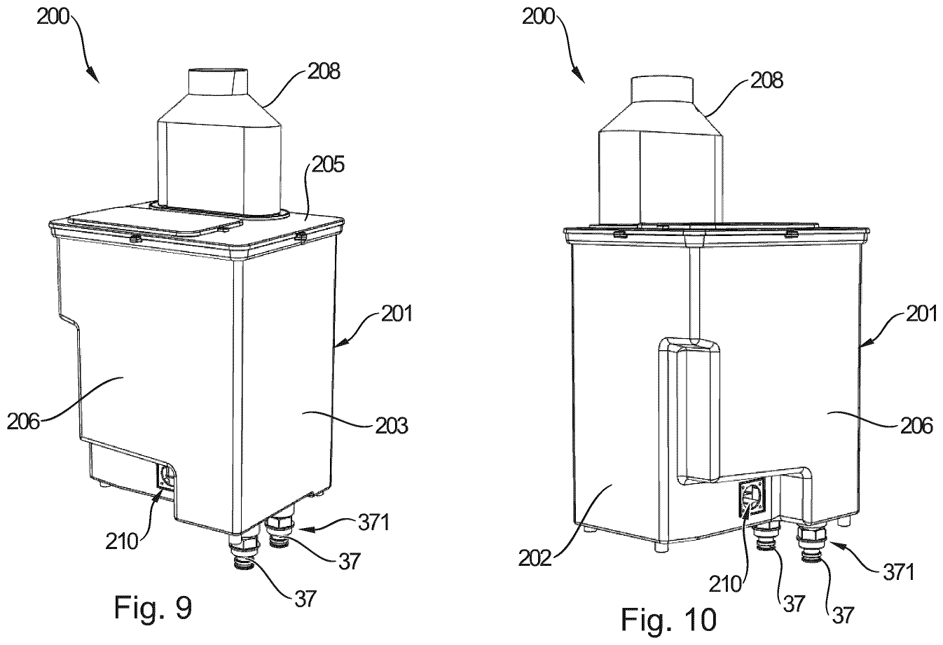

FIG. 9 is a perspective view from the side of the container 201 according to the first embodiment and FIG. 10 is a perspective view from the front of the container 201 according to the first embodiment. At the bottom wall 207 of the container 201, a heat medium pipe connection point 371 is provided for connecting the heat medium piping 37 that continues further to the indoor unit casing. In the front wall 206, a further air intake 210 is provided. In particular, the air intake 210 is provided in a lower portion of the front wall 206 of the container 201. As illustrated in FIG. 9 and FIG. 10 of the first embodiment, the front wall 206 of the container 201 may be recessed in the lower portion so that the air intake 210 is partially covered by the front wall 206. Alternatively, it is also possible that the air intake 210 is not provided in the first embodiment.

### First Modification of the First Embodiment

A first modification of the first embodiment is shown in the schematic view of FIG. 4. The first modification of the first embodiment differs from the embodiments described above in the configuration of the first duct. Nonetheless, the description of similar elements than the ones of the previously described embodiments will be omitted.

FIG. 4 is a schematic view illustrating the container 201 with a first duct 208 of the first modification of the first embodiment of the present disclosure. In the first duct 208 of the first modification of the first embodiment no ventilation duct 214 is provided. Hence, the refrigerant piping 14 is only disposed in the first duct 208 of the first modification of the first embodiment. The first duct 208 communicates the inside of the container 201 with the outdoor space for air exchange between the inside of the container 201 and the outdoor space. By this, it is possible for air in the inside of the container 201 to flow to the outdoor space. The outdoor space is where the outdoor unit 100 is located. The fan 211 is provided at an end of the first duct 208 opening into the outdoor space. The fan 211 is configured to generate an airflow from the inside of the container 201 to the outdoor space through the first duct 208. This airflow in the first duct 208 is a forced airflow by the fan 211. Accordingly, possible leaked refrigerant is transported by the airflow to the outdoor space. Preferably, the container 201 further comprises an air intake 210. As air is transported through the first duct 208 to the outdoor space, a negative pressure may be created in the container 201. By the provision of the air intake 210 it is further possible that air can inflow from the indoor space in the container. The container 201 further accommodates a refrigerant leakage detector 212, which is arranged below the gas purge valve 313. Preferably, the refrigerant leakage detector 212 is provided below the intermediate heat exchanger 20 and near the air intake 210. By the refrigerant leakage detector 212 a possible refrigerant leakage in the container 210 is detected. If refrigerant leakage in the container 210 is detected by the refrigerant leakage detector 212, the refrigerant leakage detector 212 is configured to control a motor of the fan 211, so that the fan 211 is operated by the motor and the leaked refrigerant is transported to the outdoor space. The container 201 allows that a possible leaked refrigerant is accumulated in the container 2010 and is transported to the outdoor space so that no leaked refrigerant enters the indoor space.

In addition, the container 201 of the first modification of the first embodiment may also comprise a third duct connection 218 (not illustrated in FIG. 4). The third duct connection 218 may allow for a liquid drainage of accumulated liquid in the container 201 to the outdoor space.

### Second Embodiment

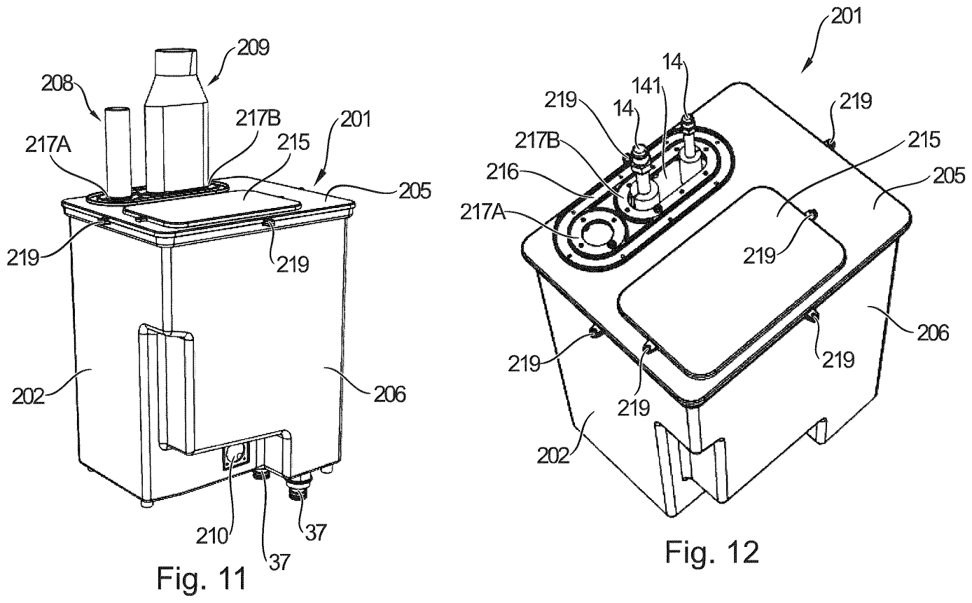

A second embodiment is shown in FIG. 3, FIG. 11, and FIG. 12. The second embodiment differs from the other embodiments described above that a second duct is provided and in the configuration of the first duct. Nonetheless, the description of similar elements than the ones of the previously described embodiments will be omitted.

FIG. 3 is a schematic view illustrating the container 201 with a first duct 208 and a second duct 209 of the second embodiment of the present disclosure.

The heat pump 1 of the second embodiment comprises an outdoor unit 100 and the container 201 of the indoor unit 300. The outdoor unit is separated by a house wall 40 from the indoor unit 300. The first duct 208 extends through a first opening in the house wall 40 to the outdoor space and the second duct 209 extends through a second opening in the house wall 40 to the outdoor space. The first duct 208 is separate from the second duct 209. The first duct 208 communicates an inside of the container 201 with the outdoor space for air exchange between the inside of the container 201 and the outdoor space. The second duct 209 also communicates the inside of the container 201 with the outdoor space for air exchange between the inside of the container 201 and the outdoor space. Thus, by the provision of the first duct 208 and the second duct 209 it is possible that supply air enters the container 201 through the first duct 208 and that exhaust air flows out of the container 201 through the second duct 209. It is also possible that air is supplied to the container 201 through the second duct 209 and that the air is exhausted from the container 201 through the first duct 208. The second duct 209 is provided at a lower portion of the container and may be inclined to the outdoor space so that a liquid can flow towards the outdoor space. Alternatively, the second duct 209 may be arranged at the bottom wall 207 of the container 201 and may be inclined to the outdoor space. Accumulated liquid may flow on the inclined bottom wall 207 towards the second duct 209 and to the outdoor space.

As illustrated in FIG. 3, the liquid refrigerant pipe 142 and the gas refrigerant pipe 143 are disposed in the second duct 209. Alternatively, the liquid refrigerant pipe 142 may be disposed in the first duct 208 and the gas refrigerant pipe 143 may be disposed in the second duct 209.

In the second embodiment the air intake 210 may be optionally provided in the container 201. The container 201 of the second embodiment accommodates, similar to the first embodiment, the intermediate heat exchanger 20, the gas purge valve 313, the gas-liquid separator 31, the pressure relief valve 314, and the refrigerant leakage detector 212. The gas-liquid separator 31 and the pressure relief valves 314 are provided in the heat medium piping 37 in the heat medium circuit 30. In case of a refrigerant leakage from the gas purge valve 313 or from the pressure relief valve 314 it is possible that an accumulated liquid of the container flows out of the second duct 209.

FIG. 11 is a perspective view from the side of the container 201 according to the second embodiment and FIG. 12 is a perspective view from above of the container 201 according to the second embodiment. The container as illustrated in FIG. 12 is also compatible with the first embodiment and third embodiment. The first duct 208 and the second duct 209 are arranged on one side of the container 201, in particular at the top wall 205 of the container 201. The first duct 208 and the second duct 209 are attached to the top wall 205 of the container 201. The top wall 205 comprises a first inner duct connection 217A and a second inner duct connection 217B. The first duct 208 is attached to the first inner duct connection 217A and the second duct 209 is attached to the second inner duct connection 217B. The first duct 208 and the second duct 209 can be attached by connecting elements including a sealing to the top wall 205 of the container 201. The connection between the first duct 208 and the second duct 209 with the top wall 205 is airtight. The top wall 205 also provides a detachable lid 215. The detachable lid 215 is attached to the top wall 205, preferably by connecting elements 219. The top wall 205 is attached to the front wall 206, the rear wall 204, the first side wall 202 and the second side wall 203 by connecting elements 219. In the front wall 206 of the container 206 an air intake 210 may be provided. In the bottom wall 207 of the container 201 the heat medium piping 37 is provided that continues to the indoor unit casing.

### First Modification of the Second Embodiment

A first modification of the second embodiment is shown in the schematic view of FIG. 5. The first modification of the second embodiments differs from the embodiments described above in the configuration of the first duct and second duct. Nonetheless, the description of similar elements than the ones of the previously described embodiments will be omitted.

FIG. 5 is a schematic view illustrating the container 201 with a first duct 208 and a second duct 209 of the first modification of the second embodiment of the present disclosure. In the first modification of the second embodiment, the refrigerant piping is disposed in the first duct 208, and the second duct 209 is only used for air ventilation. It is also possible that the second duct 209 of the first modification of the second embodiment is arranged at the lowest portion of the container so that a liquid can flow towards the outdoor space. The second duct 209 may be arranged at the lowest position of the container 201 and may have an inclination towards the outdoor space so that accumulated liquid flows towards the outdoor space. As illustrated in FIG. 5, the container 201 may be wall mounted.

### Third Embodiment

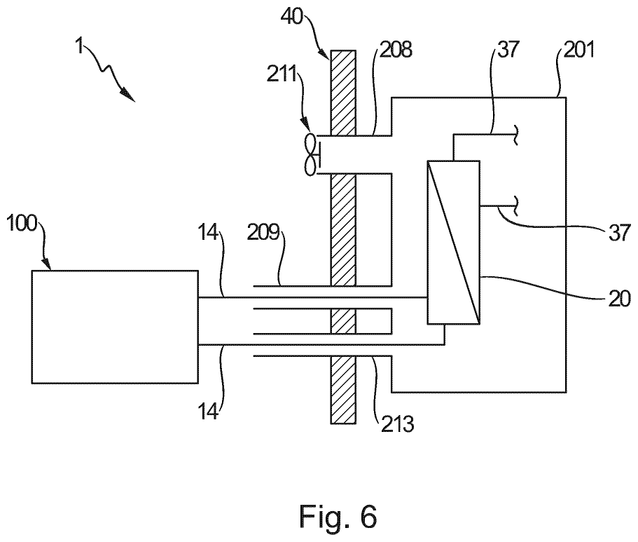

A third embodiment is shown in FIG. 6 and FIG. 13. The third embodiment differs from the other embodiments described above that a first duct, a second duct and a third duct are provided and in the configuration of the first duct. Nonetheless, the description of similar elements than the ones of the previously described embodiments will be omitted.

FIG. 6 is a schematic view illustrating the container 201 with a first duct 208, a second duct 209, and a third duct 213 of a third embodiment of the present disclosure.

The heat pump 1 of the third embodiment comprises an outdoor unit 100 and the container 201 of the indoor unit 300. The outdoor unit 100 is separated by a house wall 40 from the indoor unit. The container 201 comprises at least the intermediate heat exchanger 20, a part of the refrigerant piping 14, a part of the heat medium piping 37, the gas-liquid separator 31 with the gas purge valve 313 (not illustrated in FIG. 6), and the pressure relief valve 314 (not illustrated in FIG. 6). The first duct 208 extends through a first opening in the house wall 40 to the outdoor space. The second duct 209 extends through a second opening in the house wall 40 to the outdoor space. The third duct 213 extends through a third opening in the house wall 40 to the outdoor space. The first duct 208, the second duct 209, and the third duct 213 are separate to each other. The first duct 208 communicates an inside of the container 201 with the outdoor space for air exchange between the inside of the container 201 and the outdoor space. The second duct 209 communicates the inside of the container 201 with the outdoor space for air exchange between the inside of the container 201 and the outdoor space. The third duct 213 communicates the inside of the container 201 with the outdoor space for air exchange between the inside of the container 201 and the outdoor space. Thus, by the provision of the first duct 208, the second duct 209, and third duct 213 it is possible that supply air enters the container 201 through the second duct 209 and the third duct 213 and that exhaust air flows out of the container 201 through the first duct 208. It is also possible that the air enters the container 201 through the second duct 209 only, that the air flows out of the container 201 through the first duct 208, and that the accumulated liquid flows out of the container 201 through the third duct 213.

The liquid refrigerant pipe 142 is disposed in the second duct 209 and the gas refrigerant pipe 143 is disposed in the third duct 213. Alternatively, the liquid refrigerant pipe 142 is disposed in the third duct 213 and the gas refrigerant pipe 143 is disposed in the second duct 209. At the outdoor end of the first duct 208 a fan 211 is provided. It is also possible that the refrigerant piping 14, including the liquid refrigerant pipe 142 and the gas refrigerant pipe 143, is arranged in the second duct 209 only. The third duct 213 may also be arranged at the lowest position of the container so that the accumulated liquid can flow out of the container. Thus, by the heat pump 1 of the third embodiment it is ensured that no refrigerant may leak into the indoor space.

FIG. 13 is a perspective view from the rear of the container 201 according to the third embodiment. The container 201 of the third embodiment may be the container 201 of the first embodiment or second embodiment. The first duct 208 and the second duct 209 are arranged on one side of the container 201, in particular at the top wall 205 of the container 201 (not illustrated). The first duct 208 and the second duct 209 are attached to the top wall 205 of the container 201. The top wall 205 comprises a first inner duct connection 217A and a second inner duct connection 217B. The first duct 208 is attached to the first inner duct connection 217A and the second duct 209 is attached to the second inner duct connection 217B. The first duct 208 and the second duct 209 can be attached by connecting elements including a sealing to the top wall 205 of the container 201. The connection between the first duct 208 and the second duct 209 with the top wall 205 is airtight. The top wall 205 also provides a detachable lid 215. The detachable lid 215 is attached to the top wall 205, preferably by connecting elements 219. The top wall 205 is attached to the front wall 206, the rear wall 204, the first side wall 202 and the second side wall 203 by connecting elements 219.

In the rear wall 204 of the container 206 a third duct connection 218 is provided. The third duct 213 is arranged on one side of the container 201, in particular at the rear wall 204 of the container (not illustrated). The third duct 213 is attached to the third duct connection 218. The connection between the third duct 213 and the third duct connection 218 is airtight. The third duct connection 218 is provided at the lowest position of the container 201. The provision of the third duct connection 218 at the lowest position allows that the accumulated liquid can flow from the container 201 to the outdoor space.

In the first duct 208 the refrigerant piping 14 is arranged. In the second duct 209 air exchange with the outdoor space and the container is possible. In the third duct 213 air exchange with the outdoor space and the container is possible and accumulated liquid may flow from the container to the outdoor space.

The bottom wall 207 of the container 201 (not illustrated) is further constructed with an inclination so that accumulated liquid flows towards the third duct connection 218. The third duct 213 is further constructed with an inclination so that the accumulated liquid further flows towards an outdoor space. It is also possible that in the third duct 213 a separate drain pipe is provided. Through the drain pipe the accumulated liquid may be drained to the outdoor space. Accordingly, by the heat pump 1 of the third embodiment a leakage of refrigerant in the indoor space is prevented. By the provision of the first to third duct it is possible that a leaked refrigerant and heat medium are ventilated and/or transported to the outdoor space so that a low concentration of refrigerant can be maintained in the container 201 in case of a refrigerant leakage.

### Fourth Embodiment

The fourth embodiment uses the heat pump 1 as previously described, and as illustrated in FIG. 1. Thus, the description of similar elements than the ones of the previously described will be omitted. The fourth embodiment comprises a heat pump with a first duct.

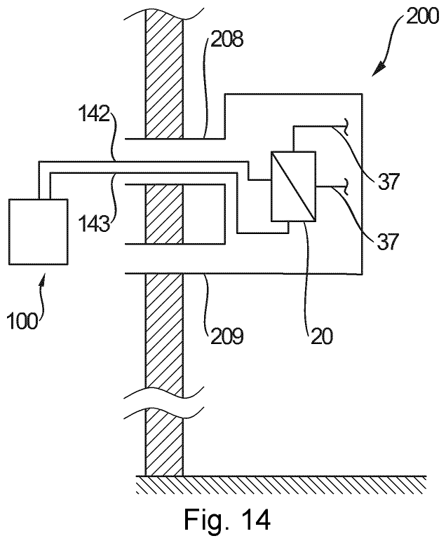

FIG. 14 is a schematic view illustrating the container 201 with a first duct 208 and second duct 209 of a fourth embodiment of the present disclosure. In the heat exchanger unit 200 of the heat pump 1, the container 201 comprises a first duct 208 and a second duct 209. The first duct 208 is arranged in an opening in the house wall 40. The first duct 208 is separate from the second duct 209. The second duct 209 is arranged in a separate opening to the first duct 208 in the house wall 40. The first duct 208 is provided at the container 201, especially at the top wall 205 of the container 201. Alternatively, the first duct 208 may be provided at the rear wall 204 of the container 201. The second duct 209 is provided at the container 201, especially at the rear wall 204 or the bottom wall 207 of the container 201. The first duct 208 has a first end that is arranged at the container 201 and a second end that is arranged in the house wall 40 and extends towards the outdoor space, where the outdoor unit 100 is situated. The first duct 208 communicate an inside of the container 201 with an outdoor space for air exchange between the inside of the container 201 and the outdoor space. The outdoor space is outside of the building, where the outdoor unit 100 is situated. The second duct 209 has a first end that is arranged at the container 201 and a second end that is arranged in the house wall 40 and extends towards the outdoor space, where the outdoor unit 100 is situated. The second duct 209 also communicates the inside of the container 201 with the outdoor space for air exchange between the inside of the container 201 and the outdoor space. Thus, by the provision of the first duct 208 and the second duct 209 it is possible that supply air enters the container 201 through the first duct 208 and that exhaust air flows out of the container 201 through the second duct 209. It is also possible that air is supplied to the container 201 through the second duct 209 and that the air is exhausted from the container 201 through the first duct 208. The second duct 209 is connected to a lower part of the container 201 for drainage of liquid from the container 201. The second duct 209 is provided at a lower portion of the container and may be inclined to the outdoor space so that a liquid can flows towards the outdoor space. Alternatively, the second duct 209 may be arranged at the bottom wall 207 of the container 201 and may be inclined to the outdoor space. Accumulated liquid may flow on the inclined bottom wall 207 towards the second duct 209 and to the outdoor space.

In the first duct 208, the gas refrigerant pipe 143 and the liquid refrigerant pipe 142 are disposed. Alternatively, the liquid refrigerant pipe 142 may be disposed in the first duct 208 and the gas refrigerant pipe 143 may be disposed in the second duct 209.

A ventilation duct (not illustrated) may be further disposed in the first duct 208. A fan (not illustrated) is provided at an end of the first duct 208 opening into the outdoor space. The fan is configured to create an airflow through the first duct 208 from the inside of the container 201 to the outdoor space. The fan can be preferably provided at an end of the ventilation duct opening into the outdoor space. Accordingly, possible leaked refrigerant of the container is transported by the airflow through the first duct to the outdoor space. In the second duct 209 a drainage for accumulated liquid is provided so that accumulated liquid in the container 201 can flow towards the outdoor space. The second duct 209 is at the lowest position of the container 201 and has an inclination towards the outdoor space so that accumulated liquid flows towards the outdoor space.

The container 201 accommodates the intermediate heat exchanger 20, the gas purge valve 313, the gas-liquid separator 31, the pressure relief valve 314, parts of the heat medium piping 37, and parts of the refrigerant piping 14. The refrigerant piping 14 comprises the liquid refrigerant pipe 142 and the gas refrigerant pipe 143. Additionally, the connections of the refrigerant piping 14 with the intermediate heat exchanger 20 are accommodated in the container 201. The gas purge valve 313 and the pressure relief valve 314 which are likely sources of refrigerant and heat medium leakage are accommodated in the container 201. Accordingly, a possible refrigerant leakage of the refrigerant piping 14 or of the components of the heat medium circuit 30 and refrigerant circuit 10 can be accumulated in the container 201 and a refrigerant leakage into the indoor space is prevented.

FIG. 7 is a perspective view from below of the container 201 according to the fourth embodiment and FIG. 8 is a perspective view from above of the container 201 according to the fourth embodiment. The heat exchanger unit 200 comprises the container 201, the first duct 208, and the second duct 209. The first duct 208 is provided at the container 201. The second duct 209 is provided at the third duct connection 218 at the lower portion of the rear wall 204 (not illustrated). The container 201 further comprises a rear wall 204, a first side wall 202, a second side wall 203, a top wall 205, and a bottom wall 207. At the bottom wall 207, a heat medium pipe connection point 371 is provided for connecting the heat medium piping 37. The heat medium piping 37 includes a first heat medium piping 37 and a second heat medium piping 37. As illustrated in FIG. 8, the first duct 208 is provided at the top wall 205. In the first duct 208, the refrigerant pipe connection point 141 is arranged for connecting the refrigerant piping 14. When the refrigerant piping 14 is connected at the refrigerant pipe connection point 141 with the intermediate heat exchanger, the refrigerant piping 14 is arranged in the first duct 208.

FIG. 9 is a perspective view from the side of the container 201 according to the fourth embodiment and FIG. 10 is a perspective view from the front of the container 201 according to the fourth embodiment. At the bottom wall 207 of the container 201, a heat medium pipe connection point 371 is provided for connecting the heat medium piping 37 that continues further to the indoor unit casing. In the front wall 206, a further air intake 210 is provided. In particular, the air intake 210 is provided in a lower portion of the front wall 206 of the container 201. As illustrated in FIG. 9 and FIG. 10 of the fourth embodiment, the front wall 206 of the container 201 may be recessed in the lower portion so that the air intake 210 is partially covered by the front wall 206. Alternatively, it is also possible that the air intake 210 is not provided in the first embodiment.

FIG. 13 is a perspective view from the rear of the container 201 according to the fourth embodiment. The first duct 208 is arranged on one side of the container 201, in particular at the top wall 205 of the container 201 (not illustrated). The first duct 208 is attached to the top wall 205 of the container 201. In the rear wall 204 of the container 206, a third duct connection 218 is provided. The second duct 209 is arranged on one side of the container 201, in particular at the rear wall 204 of the container (not illustrated). The second duct 209 is attached to the third duct connection 218. The connection between the second duct 209 and the third duct connection 218 is airtight. The third duct connection 218 is provided at the lowest position of the container 201. The provision of the third duct connection 218 at the lowest position allows that the accumulated liquid can flow through the second duct 209 from the container 201 to the outdoor space.

In the first duct 208 the refrigerant piping 14 is arranged. In the second duct 209 air exchange with the outdoor space and the container is possible and accumulated liquid may flow from the container to the outdoor space.

The bottom wall 207 of the container 201 (not illustrated) is further constructed with an inclination so that accumulated liquid flows towards the third duct connection 218. The second duct 209 is further constructed with an inclination so that the accumulated liquid further flows towards an outdoor space. It is also possible that in the second duct 209 a separate drain pipe is provided. Through the drain pipe the accumulated liquid may be drained to the outdoor space. Accordingly, by the heat pump 1 of the first embodiment a leakage of refrigerant in the indoor space is prevented. By the provision of the first duct and second duct it is possible that a leaked refrigerant and heat medium are ventilated and/or transported to the outdoor space so that a low concentration of refrigerant can be maintained in the container 201 in case of a refrigerant leakage.

### First Modification of the Fourth Embodiment

A first modification of the fourth embodiment is shown in the schematic view of FIG. 3. The first modification of the fourth embodiment differs from the embodiments described above in the configuration of the first duct 208 and second duct 209. Nonetheless, the description of similar elements than the ones of the previously described embodiments will be omitted.

In the second duct 209 of the first modification of the fourth embodiment the liquid refrigerant pipe 142 and the gas refrigerant pipe 143 are arranged. The first duct 208 of the first modification of the fourth embodiment does not accommodate the refrigerant piping 14.

Thus, in the heat pump 1 of the first modification of the fourth embodiment, the refrigerant piping 14 is arranged in the second duct 209. In the second duct 209 the drainage of liquid is further possible. In the first duct 208 only air ventilation can occur. Thus, the second duct 209 may provide an air inlet to supply air into the container 201 and may provide a drainage for accumulated liquid. The first duct 208 may provide an air outlet to exhaust air from the container 201 to the outdoor space. By the first modification of the fourth embodiment, it is easy to dispose a fan at an end of the first duct 208 opening into the outdoor space. By the first modification of the fourth embodiment the same technical effects as described for the fourth embodiment are achieved.

### REFERENCE LIST

1 Heat pump
10 Refrigerant circuit
11 Compressor
12 Heat source heat exchanger
13 Expansion valve
14 Refrigerant piping
141 Refrigerant pipe connection point
142 Liquid refrigerant pipe
143 Gas refrigerant pipe
20 Intermediate heat exchanger
30 Heat medium circuit
31 Gas-liquid separator
313 Gas purge valve
314 pressure relief valve
36 Pump
37 Heat medium piping
371 Heat medium pipe connection point
40 house wall
100 Outdoor unit
101 Outdoor unit casing
200 Heat exchanger unit
201 Container
202 First side wall
203 Second side wall
204 Rear wall
205 Top wall
206 Front wall
207 Bottom wall
208 First duct
209 Second duct
210 Air intake
211 Fan
212 Refrigerant leakage detector
213 Third duct
214 ventilation duct
215 Detachable lid
216 outer duct connection
217A first inner duct connection
217B second inner duct connection
218 third duct connection
219 connecting element
300 Indoor unit

The following itemized paragraphs also form part of the present disclosure:
Item 1. An indoor unit for a heat pump (1) installed inside of a building, comprising
   a part of a heat medium circuit (30) for circulating a heat medium,
   an intermediate heat exchanger (20) to exchange heat between a refrigerant and the heat medium,
   a pressure relief valve (314) to release the heat medium, which is provided in the heat medium circuit (30),
   a container (201) accommodating the intermediate heat exchanger (20) and the pressure relief valve (314),
   wherein the container (201) comprises a first duct (208) and a second duct (209), wherein the first duct (208) is connected to an upper part of the container (201) and communicates an inside of the container (201) with an outdoor space for air exchange between the inside of the container (201) and the outdoor space, wherein the outdoor space is outside of the building,
   wherein the second duct (209) is connected to a lower part of the container (201) for drainage of liquid from the container.
Item 2. A heat pump (1), comprising
   a refrigerant circuit (10) for circulating a refrigerant comprising a liquid refrigerant pipe (142), a heat source heat exchanger (12), a compressor (11), an expansion valve (13), a gas refrigerant pipe (143), and an intermediate heat exchanger (20),
   a heat medium circuit (30) for circulating a heat medium comprising a pump and the intermediate heat exchanger (20),
   the intermediate heat exchanger (20) to exchange heat between the refrigerant and the heat medium,
   a pressure relief valve (314) to release the heat medium, which is provided in the heat medium circuit (30),
   a container (201) accommodating the intermediate heat exchanger (20) and the pressure relief valve (314),
   wherein the container (201) comprises a first duct (208) and a second duct (209), wherein the first duct (208) is connected to an upper part of the container (201) and communicates an inside of the container (201) with an outdoor space for air exchange between the inside of the container (201) and the outdoor space, wherein the outdoor space is where the heat source heat exchanger (12) and the compressor (11) are located,
   wherein the second duct (209) is connected to a lower part of the container (201) for drainage of liquid from the container (201).
Item 3. The indoor unit according to item 1 or the heat pump according to item 2,
   wherein the second duct (209) communicates the inside of the container (201) with the outdoor space for air exchange between the inside of the container (201) and the outdoor space.
Item 4. The indoor unit or the heat pump according to any one of the preceding items, wherein
   a gas-liquid separator (31) is provided in the heat medium circuit (30), the gas-liquid separator (31) comprising a gas purge valve (313) to release refrigerant, and
   wherein the container (201) further accommodates the gas-liquid separator (31) and the gas purge valve (313).
Item 5. The indoor unit or the heat pump according to any one of the preceding items,
   wherein the container (201) comprises an air intake (210) configured to allow an airflow from outside the container (201) in the inside of the container (201).
Item 6. The indoor unit or the heat pump according to any one of the preceding items,
   wherein a fan is arranged at an outdoor end of the first duct (208), the fan being configured to generate an airflow from the inside of the container (201) to the outdoor space through the first duct (208).
Item 7. The indoor unit or the heat pump according to any one of the preceding items,
   wherein the inside of the container (201) is hermetically sealed from the outside of the container (201).
Item 8. The indoor unit or the heat pump according to any one of the preceding items,
   wherein the container (201) has a box shape with a first side wall (202) and a second side wall (203), opposing the first side wall (202), a rear wall (204) extending between the first side wall (202) and the second side wall (203), a top wall (205) being connected to upper ends of the first side wall (202), the second side wall (203), and the rear wall (204), a front wall (206) opposing the rear wall (204), and a bottom wall (207) opposing the top wall (205),
   wherein the first duct (208) is arranged at the top wall (205) of the container (201), and
   wherein the second duct (209) is arranged at the rear wall (204) or at the bottom wall (207) of the container (201).
Item 9. The indoor unit or the heat pump according to item 8,
   wherein the bottom wall (207) of the container (201) is inclined towards an opening of the second duct (209).
Item 10. The indoor unit or the heat pump according to any one of the preceding items,
   wherein the second duct (209) is arranged at a lowest position of the container (201).
Item 11. The indoor unit or the heat pump according to any one of the preceding items,
   wherein the gas refrigerant pipe (143) and the liquid refrigerant pipe (142) are disposed in the first duct (208) or in the second duct (209).
Item 12. The indoor unit or the heat pump according to any one of the preceding items,
   wherein the container further comprises a detachable lid (215).
Item 13. The indoor unit or the heat pump according to any one of the preceding items,
   wherein the first duct (208) is configured to discharge air from the inside of the container (201) to the outdoor space and the second duct (209) is configured to allow an air inflow from the outdoor space to the inside of the container (201), or
   wherein the first duct (208) is configured to allow an air inflow from the outdoor space to the inside of the container (201) and the second duct (209) is configured to discharge air from the inside of the container (201) to the outdoor space.
Item 14. The indoor unit or the heat pump according to any one of the preceding items,
   further comprising a refrigerant leakage detector (212) and the container (201) further accommodating the refrigerant leakage detector (212).
Item 15. The indoor unit or the heat pump according to any one of the preceding items,
   wherein the first duct (208) is connected to a first side of the container (201) and the air intake (210) is connected to a second side of the container (201) and the first side is different to the second side.

1. An indoor unit for a heat pump installed inside of a building, comprising
a part of a heat medium circuit for circulating a heat medium, an intermediate heat exchanger to exchange heat between a refrigerant and the heat medium,
a gas-liquid separator provided in the heat medium circuit, the gas-liquid separator comprising a gas purge valve to release refrigerant,
a container accommodating the intermediate heat exchanger, the gas purge valve, and the gas-liquid separator, and
a first duct provided at the container, the first duct communicating an inside of the container with an outdoor space for air exchange between the inside of the container and the outdoor space, wherein the outdoor space is outside of the building.

2. A heat pump, comprising
a refrigerant circuit for circulating a refrigerant comprising a liquid refrigerant pipe, a heat source heat exchanger, a compressor, an expansion valve, a gas refrigerant pipe, and an intermediate heat exchanger,
a heat medium circuit for circulating a heat medium comprising a pump and the intermediate heat exchanger,
the intermediate heat exchanger to exchange heat between the refrigerant and the heat medium,
a gas-liquid separator provided in the heat medium circuit, the gas-liquid separator comprising a gas purge valve to release refrigerant,
a container accommodating the intermediate heat exchanger, the gas purge valve, and the gas-liquid separator, and
a first duct provided at the container, the first duct communicating an inside of the container with an outdoor space for air exchange between the inside of the container and the outdoor space, wherein the outdoor space is where the heat source heat exchanger and the compressor are located.

3. The indoor unit according to claim 1,
further comprising a refrigerant leakage detector and the container further accommodating the refrigerant leakage detector.

4. The indoor unit according to claim 1,
further comprising a pressure relief valve provided in the heat medium circuit, and wherein the container further accommodates the pressure relief valve.

5. The indoor unit according to claim 1,
wherein the container comprises an air intake configured to allow an air flow from an outside of the container in the inside of the container.

6. The indoor unit according to claim 1,
wherein the gas refrigerant pipe and the liquid refrigerant pipe are disposed in the first duct.

7. The indoor unit according to claim 1, further comprising
a second duct communicating the inside of the container with the outdoor space for air exchange between the inside of the container and the outdoor space,
wherein the liquid refrigerant pipe is disposed in the first duct and the gas refrigerant pipe is disposed in the second duct, or
wherein the liquid refrigerant pipe and the gas refrigerant pipe are disposed in the second duct.

8. The indoor unit according to claim 1, wherein a ventilation duct is disposed in the first duct.

9. The indoor unit according to claim 7, further comprising
a third duct communicating the inside of the container with the outdoor space for air exchange between the inside of the container and the outdoor space,
wherein the liquid refrigerant pipe is disposed in the second duct and the gas refrigerant pipe is disposed in the third duct, or
wherein the liquid refrigerant pipe is disposed in the third duct and the gas refrigerant pipe is disposed in the second duct

10. The indoor unit according to claim 1,
wherein a fan is provided at an end of the first duct opening into the outdoor space, the fan being configured to generate an airflow from the inside of the container to the outdoor space through the first duct.

11. The indoor unit according to claim 1,
wherein the inside of the container is hermetically sealed from the outside of the container.

12. The indoor unit according to claim 7,
wherein the first duct and the second duct are arranged on one side of the container.

13. The indoor unit pump-according to claim 1,
wherein the container has a box shape with a first side wall and a second side wall, opposing the first side wall, a rear wall extending between the first side wall and the second side wall, a top wall being connected to upper ends of the first side wall, the second side wall, and the rear wall, a front wall opposing the rear wall, and a bottom wall opposing the top wall,
wherein the first duct is provided at the top wall

14. The indoor unit according claim 3,
wherein the refrigerant leakage detector is arranged below the gas purge valve.

15. The indoor unit according to claim 1, comprising
the part of a heat medium circuit for circulating the heat medium,
the intermediate heat exchanger to exchange heat between the refrigerant and the heat medium,
a pressure relief valve to release the heat medium, which is provided in the heat medium circuit,
the container accommodating the intermediate heat exchanger and the pressure relief valve,
wherein the container comprises the first duct and a second duct, wherein the first duct is connected to an upper part of the container and communicates an inside of the container with an outdoor space for air exchange between the inside of the container and the outdoor space, wherein the outdoor space is outside of the building,
wherein the second duct is connected to a lower part of the container for drainage of liquid from the container.

16. The indoor unit according to claim 15,
wherein the second duct communicates the inside of the container with the outdoor space for air exchange between the inside of the container and the outdoor space.

17. The indoor unit according to claim 15,
wherein the container has a box shape with a first side wall and a second side wall, opposing the first side wall, a rear wall extending between the first side wall and the second side wall, a top wall being connected to upper ends of the first side wall, the second side wall, and the rear wall, a front wall opposing the rear wall, and a bottom wall opposing the top wall,
wherein the first duct is arranged at the top wall of the container, and
wherein the second duct is arranged at the rear wall or at the bottom wall of the container.

18. The indoor unit according to claim 17,
wherein the bottom wall of the container is inclined towards an opening of the second duct.

19. The indoor unit according to claim 15,
wherein the second duct is arranged at a lowest position of the container.

20. The indoor unit according to claim 15,
wherein the first duct is configured to discharge air from the inside of the container to the outdoor space and the second duct is configured to allow an air inflow from the outdoor space to the inside of the container, or
wherein the first duct is configured to allow an air inflow from the outdoor space to the inside of the container and the second duct is configured to discharge air from the inside of the container to the outdoor space.
